(19) United States
(12) Patent Application Publication
(10) Pub. No.: US 2016/0009941 A1
(43) Pub. Date: Jan. 14, 2016

(54) Latex Emulsions and Coating Compositions Prepared from Latex Emulsions

(71) Applicant: AKZO NOBEL COATINGS INTERNATIONAL B.V., Arnhem (NL)

(72) Inventor: Jude Thomas Rademacher, Akron, OH (US)

(21) Appl. No.: 14/771,277

(22) PCT Filed: Mar. 11, 2014
(86) PCT No.: PCT/EP2014/054623

§ 371 Date: Aug. 28, 2015

Related U.S. Application Data
(60) Provisional application No. 61/776,074, filed on Mar. 11, 2013.

(30) Foreign Application Priority Data
May 23, 2013 (EP) 13168828.5

(51) Int. Cl. C09D 133/10; C09D 125/14; C09D 133/08

(52) U.S. Cl. CPC C09D 133/10; C09D 133/08; C09D 125/14

(57) ABSTRACT

The present invention includes coating compositions and methods for coating substrates using the coating compositions. In some embodiments of the invention, a coating composition is prepared having a latex emulsion prepared by a method including mixing an ethylenically unsaturated monomer component and a stabilizer in a carrier to form a monomer emulsion, and reacting the monomer emulsion with an initiator to form the latex emulsion, wherein the latex emulsion comprises benzyl (meth)acrylate, cyclohexyl (meth)acrylate, or a mixture thereof.

### BACKGROUND OF THE INVENTION

1. Field of the Invention

The present invention relates to latex emulsions, coating compositions formed from the latex emulsions, methods of coating substrates with the coating compositions, and substrates coated with the coating compositions.

2. Description of Related Art

Coating compositions formed from epoxy resins have been used to coat packaging and containers for foods and beverages. Although the weight of scientific evidence, as interpreted by the major global regulatory food safety agencies in the US, Canada, Europe, and Japan, shows that the levels of bisphenol A consumers are exposed to with current commercial epoxy based coatings is safe, some consumers and brand owners continue to express concern, and a coating that does not contain bisphenol A or any other endocrine disruptor is desirable.

Commonly-owned International Publication No. WO 2010/097353 describes the preparation of latex emulsions useful as packaging coating compositions.

Latexes have been developed for use in food and beverage coating compositions. Some drawbacks have been flavor acceptance in beer and blush performance in pasteurized or retorted hard-to-hold beverages. Typical latex emulsion polymers use sodium salts as buffers and stabilizers, and/or non ionic surfactants which also impart an unacceptable degree of sensitivity to water (blushing).

There is a need to produce coating compositions that do not contain bisphenol A or are substantially free of bisphenol A. In addition, styrene monomers have been widely used in coating compositions that protect food and beverages to improve corrosion resistance and adhesion to metal, but it has been recently desirable to produce such coating compositions without styrene. The latex emulsions of the invention can be used in the preparation of coating compositions suitable, inter alia, as packaging coatings for food and beverage packaging and containers.

### SUMMARY OF THE INVENTION

The present invention provides an alternate to epoxy resins and styrene monomers that still allows formaldehyde free cure, blush resistance, capability to retort and can withstand hard-to-hold beverages. In some embodiments, the latex emulsion is prepared using benzyl (meth)acrylate, cyclohexyl (meth)acrylate, or a mixture thereof, instead of epoxy resins or styrene monomers. The coating compositions of the invention can be made with a simple process, not requiring multiple polymers or processing stages to achieve the intended effect.

The present invention includes coating compositions and methods for coating substrates using the coating compositions. In some embodiments of the invention, a latex emulsion is prepared by a method comprising the steps of mixing an ethylenically unsaturated monomer component and a stabilizer in a carrier to form a monomer emulsion, and reacting the monomer emulsion with an initiator to form the latex emulsion, wherein the ethylenically unsaturated monomer component comprises benzyl (meth)acrylate, cyclohexyl (meth)acrylate, or a mixture thereof. Coating compositions prepared from the latex emulsions may exhibit no or minimal blush, no or minimal color pick-up, and commercially acceptable adhesion.

Substrates coated with the coating compositions of the invention are also disclosed. In some embodiments, the substrate is a can or packaging.

### DETAILED DESCRIPTION OF THE INVENTION

As used in the afore-discussed embodiments and other embodiments of the disclosure and claims described herein, the following terms generally have the meaning as indicated, but these meanings are not meant to limit the scope of the invention if the benefit of the invention is achieved by inferring a broader meaning to the following terms.

The present invention includes substrates coated at least in part with a coating composition of the invention and methods for coating the substrates. The term “substrate” as used herein includes, without limitation, cans, metal cans, packaging, containers, receptacles, or any portions thereof used to hold, touch or contact any type of food or beverage. Also, the terms “substrate”, “food can(s)”, “food containers” and the like include, for non-limiting example, “can ends”, which can be stamped from can end stock and used in the packaging of beverages.

The present invention includes coating compositions comprising a latex emulsion, wherein the latex emulsion may be prepared by a method comprising the steps of mixing an ethylenically unsaturated monomer component and a stabilizer in a carrier to form a monomer emulsion, and reacting the monomer emulsion with an initiator to form the latex emulsion, wherein the ethylenically unsaturated monomer component comprises benzyl (meth)acrylate, cyclohexyl (meth)acrylate, or a mixture thereof. In some embodiments, the latex emulsion is reacted with a neutralizer to form a coating composition. The latex emulsion can have an acid value of at least about 35 or about 85 based on the solids content of the latex.

The latex emulsions used in the present invention are prepared in some embodiments by techniques known in the art, such as without limitation, suspension polymerization, interfacial polymerization, and emulsion polymerization. Emulsion polymerization techniques for preparing latex emulsions from ethylenically unsaturated monomer components are well known in the polymer arts, and any conventional latex emulsion technique can be used, such as for non-limiting example, single and multiple shot batch processes, and continuous processes. If desired, an ethylenically unsaturated monomer component mixture can be prepared and added gradually to the polymerization vessel. The ethylenically unsaturated monomer component composition within the polymerization vessel may be varied during the course of the polymerization, such as, for non-limiting example, by altering the composition of the ethylenically unsaturated monomer component being fed into the vessel. Both single and multiple stage polymerization techniques can be used in some embodiments of the invention. In some embodiments, the latex emulsions are prepared using a seed polymer emulsion to control the number of particles produced by emulsion polymerization as known in the art. The particle size of the latex polymer particles is controlled in some embodiments by adjusting the initial surfactant charge.

The ethylenically unsaturated monomer component of the invention comprises benzyl (meth)acrylate, cyclohexyl (meth)acrylate, or a mixture thereof. The ethylenically unsaturated monomer component may also include, without limitation, one or more vinyl monomers, acetoacetate (meth)acrylate monomers, acrylic monomers, allylic monomers, acrylamide monomers, vinyl esters including without limitation, vinyl acetate, vinyl propionate, vinyl butyrates, vinyl benzoates, vinyl isopropyl acetates, and similar vinyl esters, vinyl halides including without limitation, vinyl chloride, vinyl fluoride and vinylidene chloride, vinyl aromatic hydrocarbons including without limitation, styrene, methyl styrenes and similar longer alkyl styrenes, chlorostyrene, vinyl toluene, vinyl naphthalene, vinyl aliphatic hydrocarbon monomers including without limitation, alpha olefins such as for non-limiting example, ethylene, propylene, isobutylene, and cyclohexene, as well as conjugated dienes such as for non-limiting example, 1,3-butadiene, methyl-2-butadiene, 1,3-piperylene, 2,3 dimethyl butadiene, isoprene, cyclohexane, cyclopentadiene, dicyclopentadiene, and combinations thereof. Vinyl alkyl ethers may include without limitation, methyl vinyl ether, isopropyl vinyl ether, n-butyl vinyl ether, isobutyl vinyl ether, and combinations thereof. Acrylic monomers may include without limitation, monomers such as for non-limiting example, lower alkyl esters of acrylic or methacrylic acid having an alkyl ester portion other than methyl or ethyl containing about 3 to about 10 carbon atoms, as well as aromatic derivatives of acrylic and methacrylic acid. Acrylic monomers may include, for non-limiting example, butyl acrylate and methacrylate, propyl acrylate and methacrylate, 2-ethyl hexyl acrylate and methacrylate, cyclohexyl acrylate and methacrylate, decyl acrylate and methacrylate, isodecylacrylate and methacrylate, benzyl acrylate and methacrylate, butane diol dimethacrylate, various glycidyl ethers reacted with acrylic and methacrylic acids, hydroxyl alkyl acrylates and methacrylates such as without limitation, hydroxyethyl and hydroxy propyl acrylates and methacrylates, and amino acrylates and methacrylates, and combinations thereof. In some embodiments, the ethylenically unsaturated monomer component is present in an amount from about 1 to about 85 wt % of the polymer composition.

In some embodiments, the ethylenically unsaturated monomer component used to form the latex emulsion includes at least one multi-ethylenically unsaturated monomer component effective to raise the molecular weight and crosslink the polymer. Non-limiting examples of multi-ethylenically unsaturated monomer components include allyl (meth)acrylates, tripropylene glycol di(meth)acrylate, diethylene glycol di(meth)acrylate, ethylene glycol di(meth)acrylate, 1,6-hexanediol di(meth)acrylate, 1,3-butylene glycol (meth)acrylate, polyalkylene glycol di(meth)acrylate, diallyl phthalates, trimethylolpropane tri(meth)acrylate, divinylbenzene, divinyltoluene, trivinylbenzene, divinylnaphthalene, and combinations thereof. In some embodiments, the multi-ethylenically unsaturated monomer component is present in an amount from about 0.1 to about 10 wt % of the polymer composition.

In some embodiments of the invention, the ethylenically unsaturated monomer component used to form the latex emulsion is mixed with a stabilizer to form the monomer emulsion. Optionally, a base is present in the mixture. In some embodiments, the stabilizer is present in an amount from about 0.1% to 2.0% by weight polymeric solids. Non-limiting examples of stabilizers may include strong acids, such as without limitation, dodecylbenzene sulfonic acid, dinonylnaphthalene sulfonic acid, dinonylnaphthylenedisulfonic acid, bis(2-ethylhexyl)sulfosuccinic acid and the like, as well as combinations thereof. In some embodiments, a strong acid is an acid with a dissociation constant in aqueous solution, pKa less than about 4. In some embodiments, the strong acid has a hydrophobe attached to the acid. In some embodiments, the strong acid has at least about six carbon atoms. Non-limiting examples of the base include ammonia, dimethylethanolamine, 2-dimethylamino-2-methyl-1-propanol, and combinations thereof. In some embodiments, the base is present in an amount of about 50% to 100% mole to mole of stabilizer.

In some embodiments, the carrier used to form the latex emulsion includes, without limitation, water, a water soluble co-solvent, and combinations thereof. The carrier is present in an amount of about 50 to about 90% of the total latex emulsion in some embodiments.

In some embodiments of the invention, the ethylenically unsaturated monomer component emulsion is reacted with one or more initiators to form a latex emulsion. The initiator may include, for non-limiting example, initiators which thermally decompose at the polymerization temperature to generate free radicals. Examples of initiators include, without limitation, both water-soluble and water-insoluble species, as well as combinations thereof. Examples of free radical-generating initiators may include, for non-limiting example, persulfates, such as without limitation, ammonium or alkali metal (potassium, sodium or lithium) persulfate, azo compounds such as without limitation, 2,2′-azo-bis(isobutyronitrile), 2,2′-azo-bis(2,4-dimethylvaleronitrile), and 1-t-butyl-azocyanocyclohexane), hydroperoxides such as without limitation, t-butyl hydroperoxide and cumene hydroperoxide, peroxides such as without limitation, benzoyl peroxide, caprylyl peroxide, di-t-butyl peroxide, ethyl 3,3′-di(t-butylperoxy) butyrate, ethyl 3,3′-di(t-amylperoxy) butyrate, t-amylperoxy-2-ethyl hexanoate, and t-butylperoxy pivilate, peresters such as without limitation, t-butyl peracetate, t-butyl perphthalate, and t-butyl perbenzoate, percarbonates, such as without limitation, di(1-cyano-1-methylethyl)peroxy dicarbonate, perphosphates, and the like, as well as combinations thereof.

In some embodiments, the initiator is used alone or as the oxidizing component of a redox system, which may include, without limitation, a reducing component such as, for non-limiting example, ascorbic acid, malic acid, glycolic acid, oxalic acid, lactic acid, thioglycolic acid, or an alkali metal sulfite, such as without limitation, a hydrosulfite, hyposulfite or metabisulfite, such as without limitation, sodium hydrosulfite, potassium hyposulfite and potassium metabisulfite, sodium formaldehyde sulfoxylate, or a combinations thereof. The reducing component can be referred to as an accelerator or a catalyst activator.

The initiator and accelerator, which can be referred to as an initiator system, are each employed in some embodiments in proportion from about 0.001% to about 5%, based on the weight of ethylenically unsaturated monomer component to be copolymerized during formation of the latex emulsion. Promoters such as without limitation, chloride and sulfate salts of cobalt, iron, nickel or copper are optionally employed in amounts from about 2 to about 200 parts per million in some embodiments. Non-limiting example of redox catalyst systems include, without limitation, tert-butyl hydroperoxide/sodium formaldehyde sulfoxylate/Fe(II), and ammonium persulfate/sodium bisulfite/sodium hydrosulfite/Fe(II), and combinations thereof. In some embodiments, the polymerization temperature is from about room temperature to about 90° C., and the temperature can be optimized for the initiator system employed, as is conventional.

In some embodiments of the invention, aggregation of polymeric latex particles is limited by including a stabilizing surfactant during polymerization. For non-limiting example, the growing latex particles may be stabilized during emulsion polymerization by one or more surfactants such as, without limitation, dodecylbenzene sulfonic acid, an anionic or nonionic surfactant, or a combination thereof, as is well known in the polymerization art. Other types of stabilizing agents, such as, without limitation, protective colloids, can be used in some embodiments. Generally speaking, conventional anionic surfactants with metal, nonionic surfactants containing polyethylene chains and other protective colloids tend to impart water sensitivity to the resulting films. In some embodiments of the invention, it is desirable to minimize or avoid the use of these conventional anionic and nonionic surfactants. In some embodiments, the stabilizing surfactant is employed during seed polymerization.

Chain transfer agents are used in some embodiments of the invention to control the molecular weight of the latex emulsion. Non-limiting examples of chain transfer agents may include mercaptans, polymercaptans, polyhalogen compounds, alkyl mercaptans such as without limitation, ethyl mercaptan, n-propyl mercaptan, n-butyl mercaptan, isobutyl mercaptan, t-butyl mercaptan, n-amyl mercaptan, isoamyl mercaptan, t-amyl mercaptan, n-hexyl mercaptan, cyclohexyl mercaptan, n-octyl mercaptan, n-decyl mercaptan, n-dodecyl mercaptan, mercapto carboxylic acids and their esters, such as without limitation, methyl mercaptopropionate and 3-mercaptopropionic acid, alcohols such as without limitation, isopropanol, isobutanol, lauryl alcohol and t-octyl alcohol, halogenated compounds such as without limitation, carbon tetrachloride, tetrachloroethylene, tricholoro-bromoethane, and combinations thereof. In some embodiments, from about 0 to about 10% by weight, based on the weight of the ethylenically unsaturated monomer component mixture is used. The latex emulsion molecular weight may be controlled in some embodiments by techniques known in the art, such as without limitation, by the ratio of initiator to ethylenically unsaturated monomer component.

In some embodiments, the initiator system and/or chain transfer agent is dissolved or dispersed in separate fluid mediums or in the same fluid medium, and then gradually added to the polymerization vessel. In some embodiments, the ethylenically unsaturated monomer component used to form the latex emulsion, either neat or dissolved or dispersed in a fluid medium, is added simultaneously with the catalyst and/or the chain transfer agent. The catalyst is added to the polymerization mixture to “chase” residual monomer after polymerization has been substantially completed to polymerize the residual monomer as is well known in the polymerization arts.

In some embodiments, an additional monomer mixture of an ethylenically unsaturated monomer component and a stabilizer is added to the monomer emulsion used to form the latex emulsion. Optionally, a base is present in the additional monomer mixture. The additional monomer mixture can be added to the monomer emulsion in some embodiments prior to addition of the initiator, after addition of the initiator, or both before and after addition of the initiator. The compositions of the ethylenically unsaturated monomer component, stabilizer and base in the additional monomer mixture can be the same as or different than the compositions of these components in the monomer emulsion.

The latex emulsion may be reacted with a neutralizer in some embodiments of the invention to form a coating composition. In some embodiments, the reaction occurs in the presence of a solvent. For non-limiting example, the solvent may include a ketone, an aromatic solvent, an ester solvent, a hydroxyl functional solvent, or a combination thereof. In some embodiments, the solvent is present in an amount from about 0% to about 90% by weight polymeric solids.

In some embodiments, the neutralizer may include, without limitation, ammonia, a tertiary amine, such as, for non-limiting example, dimethylethanolamine, 2-dimethylamino-2-methyl-1-propanol, tributylamine, or a combination thereof. For non-limiting example, the neutralizer may be employed in an amount from about 0% to about 100% based on of the amount of acid to be neutralized in the system.

The latex emulsions themselves may function as coating compositions. The latex emulsions and the coating compositions of the invention can include conventional additives known to those skilled in the art, such as without limitation, additives to control foam, reduce equilibrium and dynamic surface tension, control rheology and surface lubricity. Amounts can vary depending on desired coating application and performance in any manner known to those skilled in the art.

One or more coating compositions of the invention are applied to a substrate in some embodiments, such as for non-limiting example, cans, metal cans, packaging, containers, receptacles, can ends, or any portions thereof used to hold or touch any type of food or beverage. In some embodiments, one or more coatings are applied in addition to the coating composition of the present invention, such as for non-limiting example, a prime coat may be applied between the substrate and a coating composition of the present invention.

The coating compositions can be applied to substrates in any manner known to those skilled in the art. In some embodiments, the coating compositions are sprayed onto a substrate. When spraying, the coating composition may contain, for non-limiting example, about 10% and about 30% by weight polymeric solids relative to about 70% to about 90% water including other volatiles such as, without limitation, minimal amounts of solvents, if desired. For some applications, typically those other than spraying, the aqueous polymeric dispersions can contain, for non-limiting example, about 20% and about 60% by weight polymer solids. Organic solvents are utilized in some embodiments to facilitate spray or other application methods and such solvents include, without limitation, n-butanol, 2-butoxy-ethanol-1, xylene, toluene, and mixtures thereof. In some embodiments, n-butanol is used in combination with 2-butoxy-ethanol-1. The coating compositions of the present invention may be pigmented and/or opacified with known pigments and opacifiers in some embodiments. For many uses, including food use for non-limiting example, the pigment is titanium dioxide. The resulting aqueous coating composition may be applied in some embodiments by conventional methods known in the coating industry. Thus, for non-limiting example, spraying, rolling, dipping, and flow coating application methods can be used for both clear and pigmented films. In some embodiments, after application onto a substrate, the coating may be cured thermally at temperatures in the range from about 130° C. to about 250° C., and alternatively higher for time sufficient to effect complete curing as well as volatilizing of any fugitive component therein.

For substrates intended as beverage containers, the coating compositions may be applied in some embodiments at a rate in the range from about 0.5 to about 15 milligrams of polymer coating per square inch of exposed substrate surface. In some embodiments, the water-dispersible coating is applied at a thickness between about 1 and about 25 microns.

### EXAMPLES

The invention will be further described by reference to the following non-limiting examples. It should be understood that variations and modifications of these examples can be made by those skilled in the art without departing from the spirit and scope of the invention.

### Example 1

To 219.82 grams of demineralized water in a reactor was added a mixture of 0.75 grams of 70% dodecylbenzenesulfonic acid in isopropanol, 3.5 grams of demineralized water and 0.10 grams of 28% ammonia. The mixture was heated to 80° C. under a nitrogen sparge. When temperature was reached, the sparge was replaced with a nitrogen blanket.

In a separate container, a pre-emulsion was prepared consisting of 150.51 grams of demineralized water, 1.50 grams of 70% dodecylbenzenesulfonic acid, 0.21 grams of 28% ammonia, 175.01 grams of benzyl acrylate, 147.01 grams of butyl acrylate and 28.00 grams of methacrylic acid. 25.11 grams of the pre-emulsion was added to the reactor and mixed for 15 minutes. Next, a mixture of 1.75 grams of ammonium persulfate and 13.46 grams of demineralized water were added to the resulting mixture and held for 15 minutes. Following the hold, the remainder of the pre-emulsion was added over 180 minutes. Upon completion of the feed, a mixture of 31.50 grams of demineralized water, 0.35 grams of ascorbic acid and 0.001 grams of iron (II) sulfate was added followed by a mixture of 3.5 grams of demineralized water and 0.88 grams of t-butyl perbenzoate. The reaction mixture was held for 15 minutes and then cooled to obtain a white latex at 35% solids.

### Example 2

Example 1 was repeated, except benzyl acrylate was replaced with benzyl methacrylate. The resulting white latex had a solids content of 35%.

### Example 3

Example 1 was repeated, except benzyl acrylate was replaced with styrene. The resulting white latex had a solids content of 35%.

### Example 4

### Preparation of Coating Composition

Each of the latexes of Examples 1-3 was blended with 92.8 grams of demineralized water, 34.94 grams of butanol, 8.55 grams of ethylene glycol monobutyl ether and 0.71 grams of ethylene glycol monohexyl ether while mixing well between each addition. Films were prepared using #12 rods on the side walls of cut down aluminum beverage cans. The films were baked for 60 seconds at 380° F.

Clear Films were Obtained with the Following Attributes:

| | | | Citric Acid | |
|---|---|---|---|---|
| | Adhesion | Corrosion | Blush | Gatorade |
| Example | Rating | Rating | Rating | Blush/Color Rating |
| 1 | 4 | 5 | 5 | 4 |
| 2 | 9 | 1 | 4 | 3 |
| 3 | 10 | 5 | 5 | 2 |

### Example 5

To 879.3 grams of demineralized water in a reactor was added a mixture of 3.0 grams of 70% dodecylbenzenesulfonic acid in isopropanol, 14.0 grams of demineralized water and 0.42 grams of 28% ammonia. The mixture was heated to 80° C. under a nitrogen sparge. When temperature was reached, the sparge was replaced with a nitrogen blanket.

In a separate container, a pre-emulsion was prepared consisting of 602.1 grams of demineralized water, 6.0 grams of 70% dodecylbenzenesulfonic acid, 0.84 grams of 28% ammonia, 792.0 grams of cyclohexyl acrylate, 409.1 grams of ethyl acrylate, 67.4 grams of glycidyl methacrylate and 131.6 grams of methacrylic acid. 100.5 grams of the pre-emulsion was added to the reactor and mixed for 15 minutes. Next, a mixture of 7.0 grams of ammonium persulfate and 53.9 grams of demineralized water were added to the resulting mixture and held for 15 minutes. Following the hold, the remainder of the pre-emulsion was added over 180 minutes. Upon completion of the feed, a mixture of 126.0 grams of demineralized water, 1.4 grams of ascorbic acid and 0.001 grams of iron (II) sulfate was added followed by a mixture of 14.0 grams of demineralized water and 3.5 grams of t-butyl perbenzoate. Next, a mixture of 853.8 grams of demineralized water and 34.8 grams of dimethylethanol amine were added. The reaction mixture was held for 60 minutes and then cooled to obtain a white latex at 35% solids.

### Example 6

Example 1 was repeated, except cyclohexyl acrylate was replaced with cyclohexyl methacrylate. The resulting white latex had a solids content of 35%.

### Example 7

Example 1 was repeated, except cyclohexyl acrylate was replaced with styrene. The resulting white latex had a solids content of 35%.

### Example 8

### Preparation of Coating Composition

Each of the latexes of Examples 5-7 was blended with 870 grams of demineralized water, 349.4 grams of butanol, 85.5 grams of ethylene glycol monobutyl ether, 7.1 grams of ethylene glycol monohexyl ether and 5.7 grams of Surfonyl 420 while mixing well between each addition. Films were sprayed onto aluminum beverage cans at 120 mg/can film weight. The films were baked for 60 seconds at 380° F.

Clear Films were Obtained with the Following Attributes:

| | | Citric | | |
|---|---|---|---|---|
| | | Acid | Citric Acid | |
| | 120 mg | Blush | Blush | |
| Example | ME (mA) | Rating | Rating | HTH ΔME (mA) |
| 1 | 0.9 | 0 | 42.8 | 87.3 |
| 2 | 0.6 | 0 | 20.8 | 112.9 |
| 3 | 0.5 | 1 | 10.3 | 54.6 |

1. A latex emulsion formed from a reaction of an initiator with a monomer emulsion, wherein the monomer emulsion is a mixture of an ethylenically unsaturated monomer component that includes at least one of benzyl (meth)acrylate or cyclohexyl (meth)acrylate with a stabilizer in a carrier.

2. (canceled)

3. The latex emulsion of claim 1, wherein the stabilizer includes a strong acid catalyst.

4. The latex emulsion of claim 3, wherein the strong acid catalyst includes at least one of a sulfonic acid, a triflic acid, a triflate salt of a metal of Group IIA, IIB, IIIA, IIIB or VIIIA of the Periodic Table of Elements (according to the IUPAC 1970 convention), or a mixture of said triflate salts.

5. The latex emulsion of claim 1, wherein the ethylenically unsaturated monomer component is present in an amount from about 1% to about 85 by weight polymeric solids.

6. The latex emulsion of claim 1, wherein the stabilizer is present in an amount from about 0.1% to about 2.0% by weight polymeric solids.

7. The latex emulsion of claim 1, wherein the mixture includes one or more of ammonia, dimethylethanolamine, or 2-dimethylamino-2-methyl-1-propanol.

8. A coating composition prepared by reacting the latex emulsion of claim 1 with a neutralizer.

9. A can or packaging coated with the coating composition of claim 8.

10. A method for preparing a latex emulsion, the method comprising:
i) mixing an ethylenically unsaturated monomer component that includes at least one of benzyl (meth)acrylate or cyclohexyl (meth)acrylate with a stabilizer in a carrier to form a monomer emulsion; and
ii) reacting the monomer emulsion with an initiator to form a latex emulsion.

11. The method of claim 10, wherein the stabilizer includes a strong acid catalyst.

12. The method of claim 11, wherein the strong acid catalyst includes at least one of a sulfonic acid, a triflic acid, a triflate salt of a metal of Group IIA, IIB, IIIA, IIIB or VIIIA of the Periodic Table of Elements (according to the IUPAC 1970 convention), or a mixture of said triflate salts.

13. The method of claim 10, wherein the stabilizer is present in an amount from about 0.1% to about 2.0% by weight polymeric solids.

14. The method of claim 10, wherein the mixing of step i) occurs in the presence of one or more of ammonia, dimethylethanolamine, or 2-dimethylamino-2-methyl-1-propanol.

15. A coating composition prepared by reaction of a neutralizer with the latex emulsion of claim 10.

16. A can or packaging coated with the coating composition of claim 15.
